(19) United States
(12) Patent Application Publication
(10) Pub. No.: US 2009/0095869 A1
(43) Pub. Date: Apr. 16, 2009

(54) CONVERTIBLE DISPLAY STAND SYSTEM AND METHOD

(76) Inventors: Joel Hazzard, Osceola, WI (US); Saeb Asamarai, Columbia Heights, MN (US); Ryan Dahl, Inver Grove Heights, MN (US); Peter Segar, Burnsville, MN (US)

Correspondence Address: INTELLECTUAL PROPERTY GROUP;FREDRIKSON & BYRON, P.A., 200 SOUTH SIXTH STREET, SUITE 4000, MINNEAPOLIS, MN, 55402, US

(21) Appl. No.: 12/249,372

(22) Filed: Oct. 10, 2008

Related U.S. Application Data
(60) Provisional application No. 60/979,522, filed on Oct. 12, 2007.

(51) Int. Cl. A47B 96/06; F16M 11/20

(52) U.S. Cl. 248/398; 248/207

(57) ABSTRACT

A convertible mounting system for selectively positioning a flat panel display on either a generally horizontal surface or a generally vertical surface. In some embodiments, the convertible mounting system includes a first mount portion and a second mount portion. The first mount portion cooperates with the second mount portion in a first orientation to position a flat panel display on a generally horizontal surface. The first mount portion also cooperates with the second mount portion in a second orientation to position the flat panel display on a generally vertical surface.

### RELATED APPLICATIONS

This application claims priority to U.S. Provisional Patent Application Ser. No. 60/979,522, filed Oct. 12, 2007, and titled “Convertible Display Stand System and Method,” the contents of which are hereby incorporated by reference.

### TECHNICAL FIELD

The invention relates to devices and methods for moveably supporting equipment including, but not limited to, flat panel display screens such as plasma screens and liquid crystal display screens.

### BACKGROUND

Display screens, such as flat panel displays, are used in a variety of situations for both work and leisure. Generally, these displays are provided from the manufacturer with a stand to place the display screen on a horizontal surface such as a desk or table. Unfortunately, many consumers desire to mount a display in an orientation that is not enabled by the stand. Such consumers must purchase additional stands or mounts and consume time and energy removing the old stand and installing the new stand or mount, as well as generate waste with the undesired old stand.

### SUMMARY OF THE INVENTION

Embodiments of the invention include a convertible mounting system for selectively positioning a flat panel display on either a generally horizontal surface or a generally vertical surface. In some embodiments, the convertible mounting system includes a first mount portion and a second mount portion. The first mount portion cooperates with the second mount portion in a first orientation to position a flat panel display on a generally horizontal surface, and the first mount portion cooperates with the second mount portion in a second orientation to position the flat panel display on a generally vertical surface. In some embodiments, the first mount portion is generally orthogonal to the second mount portion in the first orientation with respect to the second orientation. Further, degrees of motion such as tilt, pan, and/or lift can be provided in either or both of the convertible mounting system orientations. Embodiments of the invention also include methods of making and using such convertible mounting systems.

### BRIEF DESCRIPTION OF THE DRAWINGS

FIG. 1 shows a perspective view of a flat panel display and a convertible mounting system in a first orientation in accordance with an embodiment of the invention.

FIG. 2 shown a perspective view of a flat panel display and a convertible mounting system in a second orientation in accordance with an embodiment of the invention.

FIG. 3 shows a perspective view of a convertible mounting system in a first orientation in accordance with an embodiment of the invention.

FIG. 4 shows a perspective view of a convertible mounting system in a second orientation in accordance with an embodiment of the invention.

FIG. 5(a) shows an exploded perspective view of a first mount portion in accordance with an embodiment of the invention.

FIG. 5(b) shows a rear perspective view of a first mount portion in accordance with an embodiment of the invention.

FIG. 5(c) shows a front perspective view of a first mount portion in accordance with an embodiment of the invention.

FIG. 6 shows a perspective view of a second mount portion and base in accordance with an embodiment of the invention.

FIG. 7(a) shows a perspective view of a second mount portion and base in accordance with an embodiment of the invention.

FIG. 7(b) shows a perspective view of a second mount portion, base, and disassembled cover plate in accordance with an embodiment of the invention.

FIG. 7(c) shows a perspective view of a second mount portion, base, and assembled cover plate in accordance with an embodiment of the invention.

FIG. 8 shows a rear plan schematic view of a flat panel display and convertible mounting system in a second orientation in accordance with an embodiment of the invention.

FIG. 9 shows a side plan schematic view of a flat panel display and convertible mounting system in a second orientation in accordance with an embodiment of the invention.

### DESCRIPTION OF THE EMBODIMENTS

In the following detailed description, reference is made to the accompanying drawings which form a part hereof, and in which is shown by way of illustration specific embodiments in which the invention may be practiced. These embodiments are described in sufficient detail to enable those skilled in the art to practice the invention, and it is to be understood that other embodiments may be utilized and that structural changes may be made without departing from the scope of the invention. Therefore, the following detailed description is not to be taken in a limiting sense, and the scope of the invention is defined by the appended claims and their equivalents.

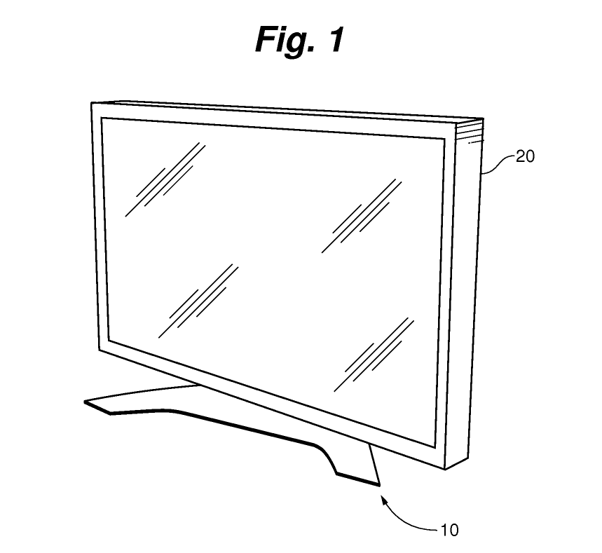

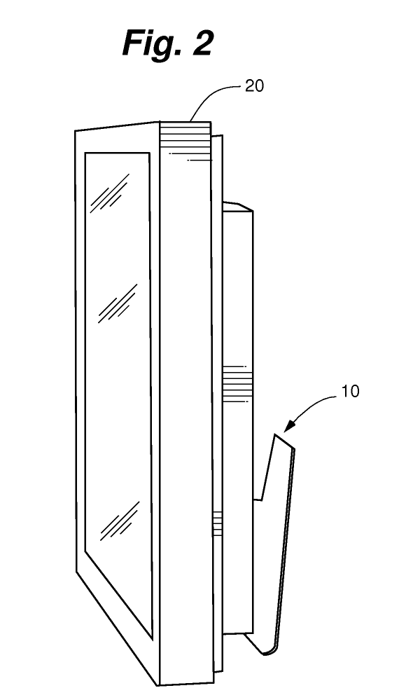

FIGS. 1 and 2 show perspective views of a flat panel display and a convertible mounting system in a first orientation and a second orientation, respectively. The convertible mounting system 10 operates to position a flat panel display 20 on a generally horizontal surface (e.g., desk top, table, floor, ceiling, desk mount via clamp or grommet mounting, etc.) or a generally vertical surface (e.g., wall, wall track mount, pole, column, etc.). The flat panel display 20 includes, but is not limited to, a plasma display, liquid crystal display (LCD), organic light-emitting diode (OLED), or the like. The convertible mounting system 10 may accommodate a wide variety of display sizes and weights.

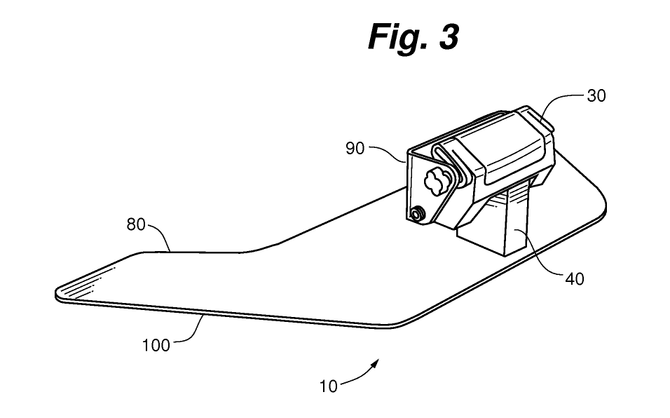

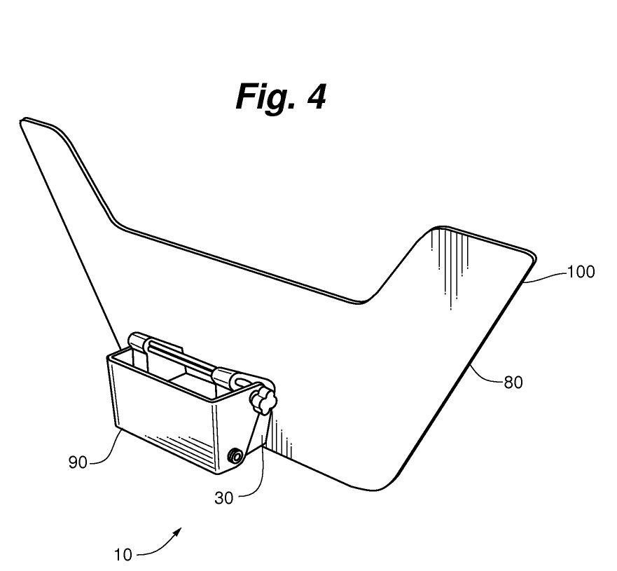

In some embodiments, the invention includes a convertible mounting system 10 for a flat panel display 20. As shown in FIG. 3, the convertible mounting system 10 can include a first mount portion 30 and a second mount portion 40. In some embodiments, as shown in FIG. 3, the first mount portion 30 cooperates with the second mount portion 40 in a first orientation to position a flat panel display 20 on a generally horizontal surface. As shown in FIG. 4, the first mount portion also cooperates with the second mount portion in a second orientation to position the flat panel display on a generally vertical surface. In certain embodiments, the first mount portion is generally orthogonal to the second mount portion in the first orientation with respect to the second orientation. This relative orthogonal relationship is useful for converting between orthogonal surfaces, such as a generally vertical surface and a generally horizontal surface.

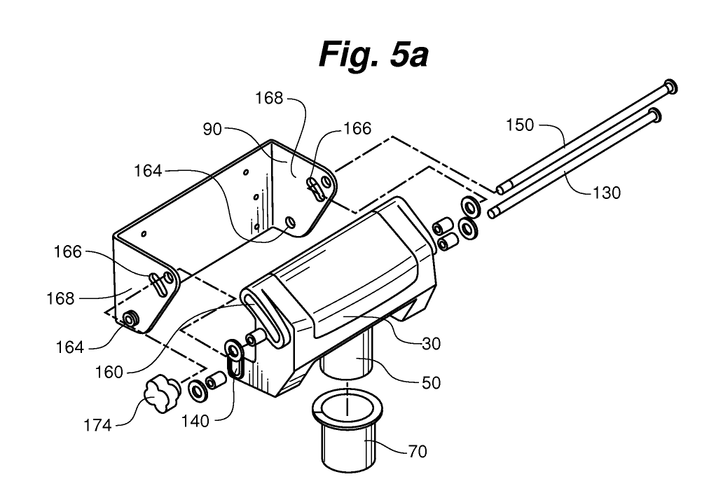

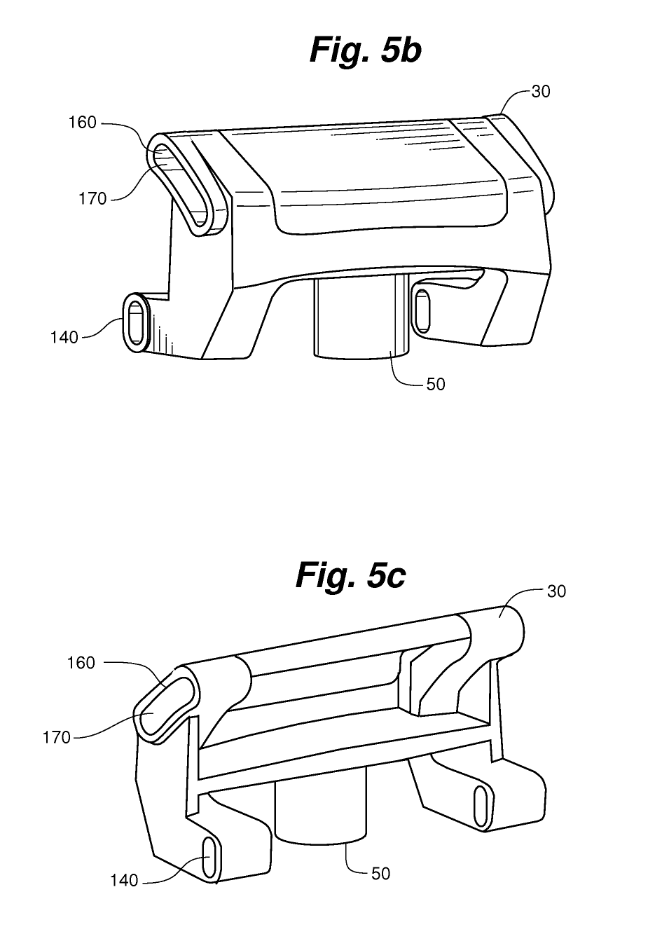

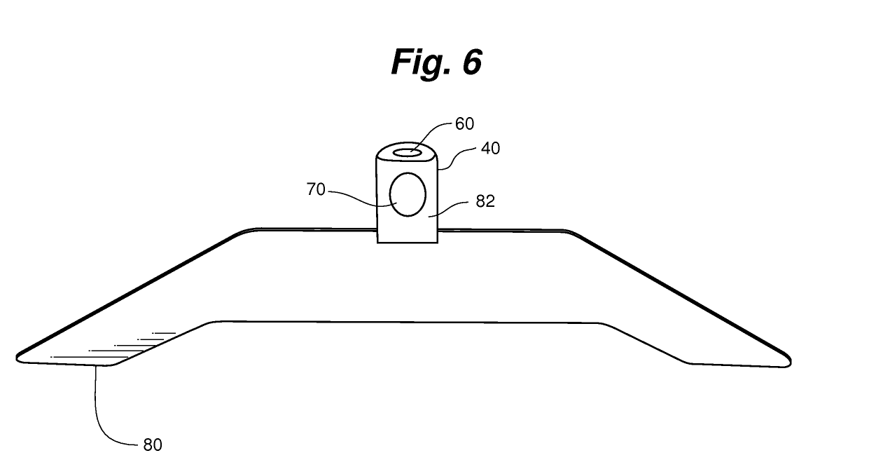

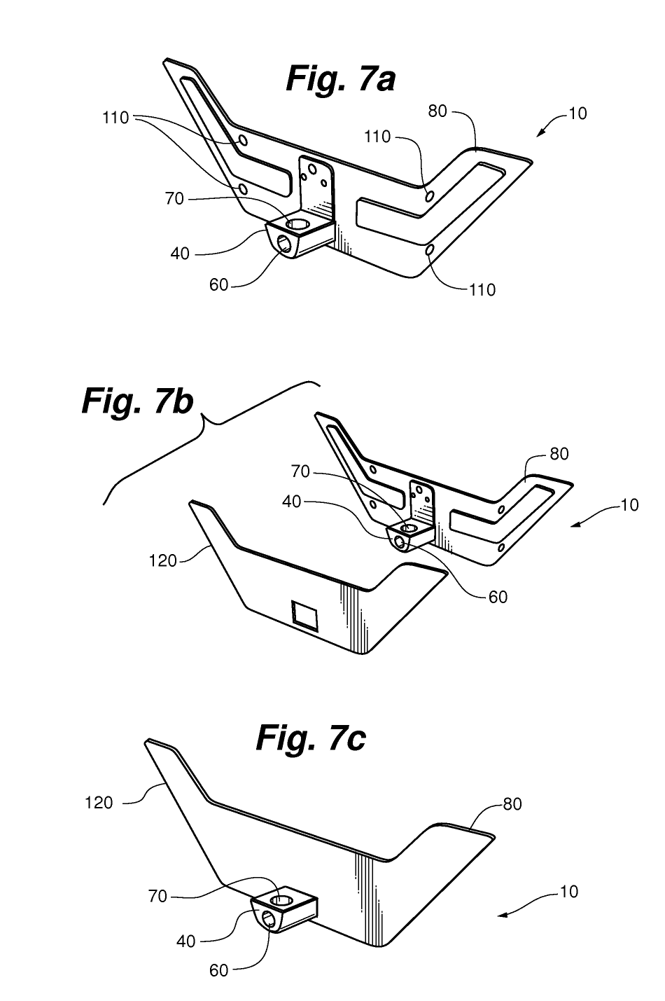

The first and second mount portions can include any structure useful for allowing conversion between a mount useful for positioning a display on a horizontal surface and a mount system useful for positioning a display on a generally vertical surface. In some embodiments, as shown in FIGS. 5(a)-(c), the first mount portion includes a first mount engaging member 50 and, as shown in FIGS. 6 and 7(a)-(c), the second mount portion can include a first second mount engaging member 60 and a second second mount engaging member 70 generally orthogonal to the first second mount engaging member. The first mount engaging member is engageable with the first second mount engaging member to provide a mounting system to position a flat panel display on a generally horizontal surface. Further, the first mount engaging member is engageable with the second second mount engaging member to provide a mounting system to position the flat panel display on a generally vertical surface. In such an embodiment, the first mount portion or the second mount portion can be connected to a flat panel display or a base 80, as discussed further below.

As shown in FIGS. 5(a)-(c), the first mount engaging member 50 can include a rigid protrusion extending generally downward when the first mount portion is coupled to the display. In such embodiments, as shown in FIG. 6, the second mount portion can include a second mount portion body 82 and the first and second second mount engaging members 60, 70 can include a first protrusion receiving aperture and a second protrusion receiving aperture, respectively, each defined by the second mount portion body. The first protrusion receiving aperture can be placed to receive the rigid protrusion of the first mount portion to position a display on a generally horizontal surface, and the second protrusion receiving aperture can be placed to receive the rigid protrusion to position the display on a generally vertical surface. In some embodiments, the first and second protrusion receiving apertures are generally orthogonal.

In some embodiments, the first mount portion 30 is adapted to connect to a flat panel display. In such embodiments, the first mount portion can include a monitor mounting plate 90 adapted to couple the first mount portion to a display. The mounting plates can take any suitable form. In some embodiments, the mounting plates engage against the flat panel display to couple the mount to the display. The mounting plates couple with the display with any suitable coupler such as bolts, bosses, adhesives or the like.

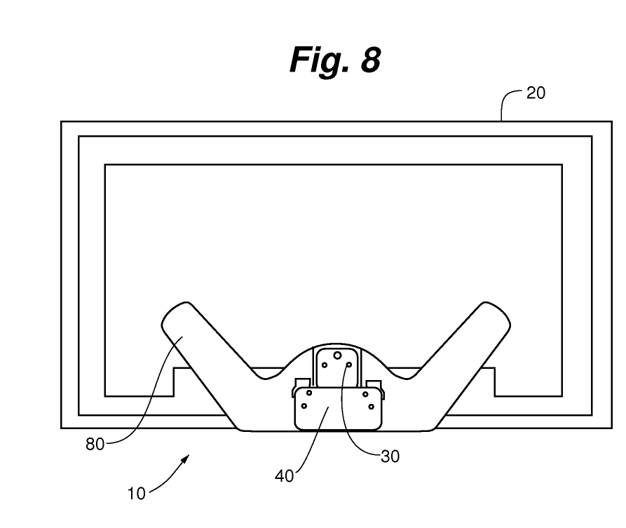

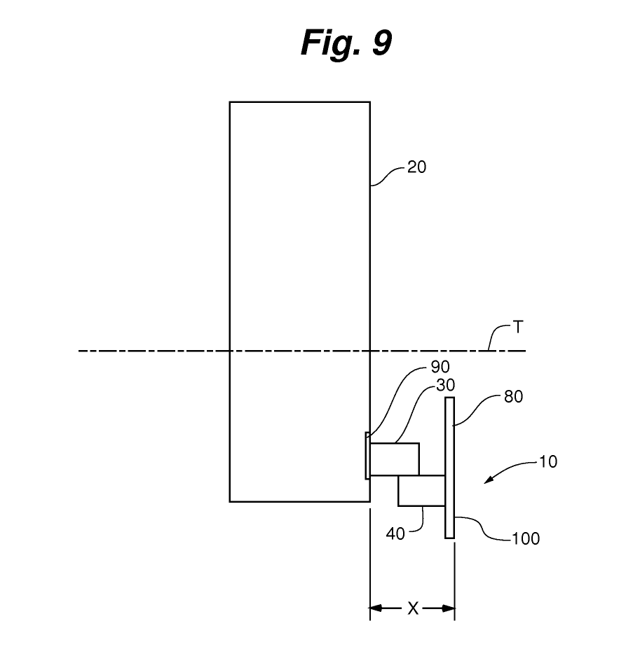

Further, the first mount portion can be attached to the flat panel display at any suitable location. For example, the monitor may be mounted to the standard VESA connection provided in the rear of a flat panel display. Such connections are usually proximate the center of gravity of the display and are generally located in the center of the display. In other embodiments, the first mount portion attaches to the display via the monitor mounting plate on the bottom third of the monitor as shown in FIG. 8 (e.g., below line T in FIG. 9). Such a mounting location allows for a tilting mount that is lower profile than connecting at the standard VESA location. For example, such a profile can be reduced from about 3-4 inches to less than about 2 inches (e.g., about 1 inch). As shown in FIG. 9, in some embodiments a horizontal distance “X” from the monitor mounting plate to the opposite edge of the first mount portion and second mount portion body is less than about two inches.

Some embodiments of the convertible mounting system 10 further include a base 80 coupled to the second mount portion 40. Such a base is useful for resting against a generally horizontal surface and for direct attachment to a generally vertical surface. In certain embodiments, the base defines a generally planar base surface 100 useful for placement on the generally horizontal surface when the rigid protrusion is received within the first protrusion receiving aperture, as shown in FIG. 3. The base also defines a generally planar vertical base surface useful for placement on the generally vertical surface when the rigid protrusion is received within the second protrusion receiving aperture, as shown in FIG. 4.

In some embodiments, as shown in FIG. 7(a), the base 80 defines mounting apertures 110 to rigidly secure the second mount portion to the generally vertical surface with a fastener (e.g., screws). In certain embodiments, the mounting apertures are placed to correspond with common wall stud spacing to facilitating mounting to a vertical surface. For example, in some embodiments at least some of the mounting apertures are spaced about 16 inches on center to align with common residential wall stud spacing in the United States. In some embodiments, as shown in FIGS. 7(b) and (c), a cover plate 120 overlaying the base is provided. Such a cover plate is useful for keeping the convertible mounting system aesthetically pleasing as it covers up mounting apertures and fasteners when the system is mounted to a generally vertical surface.

Some embodiments of the convertible mounting stand 10 allow the flat panel display 20 to be repositioned to adjust for glare or optimal viewing from multiple locations when configured to position the display on a horizontal surface and provide for a low profile mount when configured to position the display on a vertical surface. For example, degrees of motion of tilt, pan, and/or lift motion can be provided. In some embodiments, the convertible mounting system 10 provides the same movement characteristics (e.g., force profile required to move the flat panel display) regardless of whether the mounting system is in the first orientation for positioning a flat panel display on a generally horizontal surface or the second orientation for positioning a flat panel display on a generally vertical surface.

In some embodiments, the convertible mounting system 10 includes a tilt system that allows the flat panel display to be tilted relative to the base in the first and/or second orientations. The tilt can be provided by any suitable tilt system. For example, the tilt system can include a friction tilt mechanism or a torsion spring assisted tilt mechanism (for example, as described in Applicant's own U.S. Pat. No. 7,252,277, the relevant contents of which are hereby incorporated by reference). In some embodiments, the tilt system includes a gravity pivot system (for example, as described in Applicant's own US Patent Publication No. 2006/0226326, the relevant contents of which are hereby incorporated by reference). Such embodiments allow the tilt mechanism to be located below and behind the center of gravity of the display instead of being located at the same vertical location as the display's vertical center of gravity.

In some embodiments of the gravity pivot system, as shown best in FIG. 5(a), the first mount portion 30 comprises and/or cooperates with a first engaging member 130, a first surface 140 to engage the first engaging member, a second engaging member 150, and a second surface 160 to engage the second engaging member. The first and second engaging members 130, 150 may be coupled to the monitor mounting plate 90, such as by insertion through monitor mounting plate aperture sets 164, 166 defined by panels 168. In some embodiments the first and second surfaces cooperate with the first and second engaging members to continuously immobilize the display at any angle within the range of angles allowed by the mount to provide for tilt adjustment of the display when the mounting system is configured to position the display on the generally horizontal surface or to position the display on a generally vertical surface.

In some embodiments, the first surface 140 and second surface 160 cooperate to allow the display position to be easily adjusted and to continuously immobilize the display when adjustment is not desired. Continuous immobilization allows for the display to be positioned and secured at any angle within the range of angles allowed by the mount. Generally, the surfaces cooperate to balance the changing moments created by the changing center of gravity position of the display as it is moved. For example, the shape of the first and second surfaces may cooperate so that the sum of the moments about the mount remains zero, regardless of the position of the display within the range of angles allowed by the mount. The first and second surfaces may be provided in any suitable form or configuration to provide this result. For example, one or more of the surfaces can be provided within a slot 170, as shown in FIGS. 5(b) and (c). Further, one or more of the surfaces may be an existing structure, such as a wall or floor. In addition, one or more of the surfaces may be carried by the display itself.

Any amount of tilt can be provided. For example, plus or minus about 15 degrees deflection from vertical. The range of adjustment may be limited by the range of the tilt system itself, or by the manual placement of tilt stops (e.g., screws or interfering brackets) to restrict motion. Further, as shown best in FIG. 5(a), an actuator 174 (e.g., knob) can be provided to allow a user to lock the tilt position of the display relative to the mount. When desired, a user can actuate the actuator (e.g., rotate the knob about its rotational axis) to increase frictional forces and thereby “lock” the tilt position of the display relative to the mount. Of course, the actuator may also be used to unlock the tilt position of the display relative to the mount.

In some embodiments, the amount of tilt provided can be dependent upon whether the mounting system is configured to position a flat panel display on a generally vertical surface or a generally horizontal surface. For example, in the generally horizontal configuration, about −15 to about +5 degrees of tilt may be desired. In the vertical configuration, about +5 to about −15 degrees of tilt may be desired. Accordingly, some embodiments of the invention allow for the range of motion to be different depending on the orientation of the mounting system. Accordingly, in some embodiments, the manually placed tilt stops may be placed at different locations within the tilt system, as desired, depending on the orientation of the convertible mounting system.

As an example of a convertible mounting system 10 adapted to allow for panning of the display relative to the base, embodiments having a first mount engaging member 50 (e.g., rigid protrusion) mating with the first and second second mount engaging members (e.g., receiving apertures) allow for panning of the flat panel display relative to a generally horizontal surface or a generally vertical surface. For example, the rigid protrusion member may have a generally cylindrical shape and be received within a generally cylindrical aperture. Such a shape allows the rigid protrusion to articulate within the receiving aperture. If desired, pan stops (e.g., posts and/or slots) may be provided on or in the projection or corresponding receiving aperture to limit the range of pan. Further, such pan stops may be selectively engageable and/or adjustable such that more panning is permitted when the convertible mounting system is configured to position a display on a generally horizontal surface and relatively less panning is permitted with the convertible mounting system is configured to position a display on a generally vertical surface. As another example, pan may be provided by including two parallel plates coupled by a friction joint within the convertible mounting system, one of the plates being associated with the display and the other plate associated with the base. Such parallel plates allow for relative motion between them to provide for panning of the display relative to the base.

Regarding a convertible mounting system with lift, any lift system can be utilized to provide this degree of motion. For example, in embodiments having a base and a second mount portion portion, the second mount portion could include a generally vertical member having a lift mechanism, such as a gas spring or a rotary cam lift mechanism (for example, as described in Applicant's own US Patent Publication No. 2006/0185563, the relevant contents of which are hereby incorporated by reference), to allow for vertical motion of the display relative to the base. Such vertical motion can be provided when the base is orientated to sit against a generally horizontal surface or a generally vertical surface.

Embodiments of the invention also include a method of converting a flat panel display mounting system, including any of the embodiments of convertible mounting systems 10 described herein. For example, the method can include the steps of converting a mounting system from a first orientation suitable for positioning a flat panel display of a generally horizontal surface to a second orientation suitable for positioning a flat panel display on a generally vertical surface.

For example, in some embodiments, the method includes the steps of removing (e.g., lifting) a rigid protrusion of a first mount portion from a first protrusion aperture defined by a second mount portion body, the display mounting system being in a first configuration to position the display on a generally horizontal surface and inserting the rigid protrusion into a second protrusion receiving aperture defined by the second mount portion body, the second protrusion receiving aperture being generally orthogonal to the first protrusion receiving aperture, to place the mounting system in a second configuration to position the display on a generally vertical surface.

In some embodiments, the method further includes the step of attaching a base that defines a generally planar vertical base surface to the generally vertical surface. Further, in certain embodiments, the method includes the step of placing a cover plate over the base after attaching the base to the generally vertical surface and before the rigid protrusion is inserted into the second protrusion receiving aperture.

Accordingly, embodiments of the convertible mounting system allow for a cost-effective mount that is can be used in a configuration desired by a user. Further, although not limited to such, the mount may be optionally customized to a particular flat panel display and delivered in combination to a user. Such a system allows for better performing mounting systems as compared to after market mounts that must work with a variety of displays. Of course, the embodiments of convertible mounting systems described herein may also be supplied as an after market mounting system. Further, embodiments of convertible mounting systems described herein allow a consumer to use a single mount in either a horizontal or vertical configuration with a minimum of waste as the same parts are used in both configurations. Such a system also allows a consumer to quickly and easily change orientations of a display over time without having to keep two or more separate mounts on hand.

Although selected advantages are detailed above, the list is not intended to be exhaustive. Although specific examples have been illustrated and described herein, it will be appreciated by those of ordinary skill in the art that any arrangement which is calculated to achieve the same purpose may be substituted for the specific embodiment shown. This application is intended to cover any adaptations or variations of the invention. It is to be understood that the above description is intended to be illustrative, and not restrictive. Combinations of the above embodiments and other embodiments will be apparent to those of skill in the art upon reviewing the above description. The scope of the invention includes any other applications in which the above structures and fabrication methods are used.

What is claimed is:

1. A convertible mounting system for a flat panel display, comprising:
a first mount portion; and
a second mount portion, the first mount portion cooperating with the second mount portion in a first orientation to position a flat panel display on a generally horizontal surface, and the first mount portion cooperating with the second mount portion in a second orientation to position the flat panel display on a generally vertical surface, the first mount portion being generally orthogonal to the second mount portion in the first orientation with respect to the second orientation.

2. A convertible mounting system for a flat panel display, comprising:
a first mount portion having a first mount engaging member; and
a second mount portion having a first second mount engaging member and a second second mount engaging member generally orthogonal to the first second mount engaging member, the first mount engaging member engageable with the first second mount engaging member to provide a mounting system to position a flat panel display on a generally horizontal surface and the first mount engaging member engageable with the second second mount engaging member to provide a mounting system to position the flat panel display on a generally vertical surface.

3. The convertible mounting system of claim 2, wherein:
the first mount portion includes a monitor mounting plate adapted to couple the first mount portion to a display and the first mount engaging member includes a rigid protrusion extending generally downward when the first mount portion is coupled to the display; and
the second mount portion includes a second mount portion body and the first and second second mount engaging members include a first protrusion receiving aperture and a second protrusion receiving aperture, respectively, each defined by the second mount portion body, the first protrusion receiving aperture placed to receive the rigid protrusion of the first mount portion to position a display on a generally horizontal surface, and the second protrusion receiving aperture placed to receive the rigid protrusion to position the display on a generally vertical surface.

4. A convertible mounting system for a flat panel display, comprising:
a first mount portion having a monitor mounting plate adapted to couple the first mount portion to a display, the first mount portion having a rigid protrusion extending generally downward when the first mount portion is coupled to the display;
a second mount portion body defining a first protrusion receiving aperture and a second protrusion receiving aperture, the first protrusion receiving aperture placed to receive the rigid protrusion of the first mount portion to position a display on a generally horizontal surface, and the second protrusion receiving aperture placed to receive the rigid protrusion to position the display on a generally vertical surface.

5. The convertible mounting system of claim 4, the first and second protrusion receiving apertures being generally orthogonal.

6. The convertible mounting system of claim 4, wherein the first mount portion includes a gravity pivot system.

7. The convertible mounting system of claim 6, wherein the first mount portion comprises:
a first engaging member carried by the monitor mounting plate;
a first surface to engage the first engaging member;
a second engaging member carried by the monitor mounting plate; and
a second surface to engage the second engaging member, the first and second surfaces cooperating with the first and second engaging members to continuously immobilize the display at any angle within the range of angles allowed by the mount to provide for tilt adjustment of the display when the mounting system is configured to position the display on the generally horizontal surface or to position the display on a generally vertical surface.

8. The convertible mounting system of claim 4, wherein the rigid protrusion mating with the first or second protrusion receiving aperture allows for panning of the display relative to the second mount portion body.

9. The convertible mounting system of claim 4, wherein the first mount portion allows for tilt adjustment of the display relative to the second mount portion body.

10. The convertible mounting system of claim 4, further including a flat panel display, the first mount portion being attached to the display via the monitor mounting plate on the bottom third of the monitor.

11. The convertible mounting system of claim 4, wherein a horizontal distance from the monitor mounting plate to the opposite edge of the first mount portion and second mount portion body is less than about two inches when the convertible mounting system is configured to position the display on the generally vertical surface.

12. The convertible mounting system of claim 4, further including a base coupled to the second mount portion.

13. The convertible mounting system of claim 12, wherein the base defines a generally planar base surface useful for placement on the generally horizontal surface when the rigid protrusion is received within the first protrusion receiving aperture.

14. The convertible mounting system of claim 12, wherein the base defines a generally planar base surface useful for placement on the generally vertical surface when the rigid protrusion is received within the second protrusion receiving aperture.

15. The convertible mounting system of claim 12, further including a cover plate overlaying the base.

16. The convertible mounting system of claim 12, wherein the base defines mounting apertures to rigidly secure the second mount portion to the generally vertical surface.

17. A method of converting a flat panel display mounting system, comprising the steps of:
removing a rigid protrusion of a first mount portion from a first protrusion aperture defined by a second mount portion body, the display mounting system being in a first configuration to position the display on a generally horizontal surface; and
inserting the rigid protrusion into a second protrusion receiving aperture defined by the second mount portion body, the second protrusion receiving aperture being generally orthogonal to the first protrusion receiving aperture, to place the mounting system in a second configuration to position the display on a generally vertical surface.

18. The method of claim 17, further including the step of attaching a base that defines a generally planar vertical base surface to the generally vertical surface.

19. The method of claim 18, further including the step of placing a cover plate over the base after attaching the base to the generally vertical surface and before the rigid protrusion is inserted into the second protrusion receiving aperture.
